(19) United States
(12) Patent Application Publication
(10) Pub. No.: US 2026/0356022 A1
(43) Pub. Date: Nov. 12, 2026

(54) Method for Producing Porous Pellets from High Density Polyethylene Polymers

(71) Applicant: Celanese International Corporation, Irving, TX (US)

(72) Inventors: Victoria Black, Cincinnati, OH (US); Michael Joseph Molitor, Wilmington, DE (US); Yunbo Zhang, Shanghai (CN); Thomas Lovelace, Port Deposit, MD (US); Zhiqian Song, Shanghai (CN); Daijun Yu, Shanghai (CN); Denis Brel, Wilmington, DE (US)

(21) Appl. No.: 19/673,031

(22) Filed: May 11, 2026

Related U.S. Application Data
(60) Provisional application No. 63/919,775, filed on Nov. 18, 2025.

(30) Foreign Application Priority Data
May 12, 2025 (WO) PCT/CN2025/094348

(51) Int. Cl. B29C 48/00; B29C 45/00; B29C 48/05; B29C 48/14; B29C 48/40; B29C 48/76; B29K 23/00

(52) U.S. Cl. CPC B29C 48/0022; B29C 45/0001; B29C 48/022; B29C 48/05; B29C 48/145; B29C 48/40; B29C 48/767; B29C 2045/0091; B29K 2023/065; B29K 2995/0088

(57) ABSTRACT

A process is disclosed for pelletizing high density and high molecular weight polyethylene polymers. A high density polyethylene polymer resin powder is fed into a twin screw extruding device under low shear conditions. The screws contained within the extruder have a relatively high length to diameter ratio. The temperature within the extruder is controlled and ramped slowly. In one aspect, the extruder is not vented forming a porous strand which is then cut into porous pellets.

### BACKGROUND

Polyethylene has become established as an exceptionally useful engineering material in a variety of applications, in part because of its unique combination of desirable properties. For instance, high molecular weight polyethylene polymer particles may exhibit an improved abrasion resistance, chemical resistance, lubricity, impact strength, stress crack resistance, heat deflection temperature, wear resistance, and energy absorption capacity at high stress rates in comparison to other thermoplastic polymers.

High molecular weight polyethylene polymers generally include linear polyethylene polymers and can be differentiated from other polyethylene grades by a very high degree of polymerization. In fact, the high degree of polymerization is responsible for the fact that these polymers do not flow well when melted and, in fact, can display a melt flow index of less than 0.5 grams per 10 mins at 190 °C and at a load of 21.6 kg.

High molecular weight polyethylene polymers as described above, however, have various superior properties that make them desirable for a number of applications. For example, high molecular weight polyethylene polymers can have an extremely high impact strength, which is retained even at very low temperatures.

High molecular weight polyethylene polymers also have a relatively broad operating temperature range and are extremely wear resistant. In addition, high molecular weight polyethylene has great abrasion resistant properties which can be as good or better than steel.

Unlike other thermoplastic polymers, high molecular weight polyethylene polymers display very high viscosities even at elevated temperatures. Thus, the high molecular weight polyethylene polymers are difficult to process using conventional melt extrusion techniques. For example, it is challenging and difficult to convert the high molecular weight polyethylene polymer resin into pellets that then can be used in other molding processes, such as injection molding. Without an efficient and economical method for converting the resin into pellets, the use of high molecular weight polyethylene polymers in injection molding processes and other melt processing systems has been limited.

For instance, high molecular weight polyethylene polymers have a relatively low melting temperature for their high molecular weight which results in very poor flow characteristics when molten. Further, if the temperature is increased too much to cause the polymer to flow, the polymer can be subjected to oxidation and degradation. Consequently, extruding high molecular weight polyethylene into strands and cutting these strands into pellets can be a relatively complex process. For instance, when extruded, the processing of high molecular weight polyethylene polymers can be very unstable. The strands are easily dropped, and the high molecular weight polyethylene material can get stuck in the extruder, locking the screw. Locked screws require significant down time and cleaning before attempts can be made to restart the process.

Even when extruded into a strand, the strength and toughness of high molecular weight polyethylene polymers make cutting the strand into pellets mechanically demanding. Specialized equipment is often required to deal with this unique combination of toughness and non-melt processability. For instance, in the past, those skilled in the art have resorted to cryogenic grinding in order to convert the high molecular weight polyethylene polymer into particles that can be melt processed.

In view of the above, a need currently exists for an efficient method and process for pelletizing a high molecular weight polyethylene resin. A need also exists for a high molecular weight polyethylene pelletized product that can be used in conventional melt processing equipment, such as in injection molding processes.

### SUMMARY

In general, the present disclosure is directed to a process for producing porous pellets from high molecular weight polyethylene polymer resins. The porous pellets are formed using a multi-screw extruder under low shear conditions. During the process, a porous strand is produced that can easily be cut into pellets without having to use complex mechanical equipment or cryogenic freezing of the polymer. The porous pellets that are produced are well suited for use in producing all different types of articles, parts and components. For instance, the porous pellets are well suited for being fed into an injection molding process for producing three-dimensional articles.

In one embodiment, for instance, the present disclosure is directed to a process for forming a high density polyethylene product. The process includes feeding one or more high density polyethylene polymer resin powders into a twin screw extruder. The high density polyethylene resin powder(s) can have a density of about 0.92 g/cm³ or greater and an average molecular weight of about 400,000 g/mol or greater. For instance, the average molecular weight of the high density polyethylene can be greater than about 500,000 g/mol, such as greater than about 700,000 g/mol, such as greater than about 1,000,000 g/mol, such as greater than about 1,500,000 g/mol, such as greater than about 2,000,000 g/mol, such as greater than about 3,000,000 g/mol, and less than about 12,000,000 g/mol, such as less than about 10,000,000 g/mol, such as less than about 8,000,000 g/mol, such as less than about 7,000,000 g/mol, such as less than about 5,000,000 g/mol.

The twin screw extruder includes a barrel that houses two cooperating screws. The screws rotate within the barrel and include flights that convey the high molecular weight polyethylene resin powder from one end of the barrel to an opposite end of the barrel. The two cooperating screws can both rotate in the same direction or can rotate in opposite directions. The barrel has a length that is divided into temperature sections. For instance, each temperature section can be independently controlled. In accordance with the present disclosure, the screws have an L/D (length over diameter) of about 30 or greater, such as greater than about 34. For instance, the L/D of the screws can be about 36 or greater, such as about 38 or greater, such as about 40 or greater, such as about 42 or greater, and less than about 70.

The twin screw extruder includes a conveying zone, a kneading zone, and an exit zone. The conveying zone is greater than about 50% of the length of the screws. During the process, over the first 40% of the length of the barrel within the conveying zone, the temperature is maintained below about 60 °C, such as below about 55 °C, such as below about 50 °C, and greater than about 20 °C. The temperature within the kneading zone and the exit zone is maintained above between about 100 °C and about 275 °C. For example, the temperature can be greater than about 120 °C, such as greater than about 150 °C, such as greater than about 180 °C, such as greater than about 200 °C, and less than about 250 °C, such as less than about 230 °C.

Within the kneading zone and the exit zone, the high molecular weight polyethylene polymer resin becomes molten and flows forming a strand. In one aspect, the extruder is vented in order to release gases contained in the barrel. Alternatively, devolitilized gases remain in the barrel during the process.

The porous strand exits the extruder and is cut into pellets. For instance, in one embodiment, the porous strand is fed into a bath, cooled, and then cut into pellets. The resulting pellets are porous making them well suited for use in downstream processes for producing molded articles.

The polymer composition fed to the twin screw extruder in accordance with the present disclosure can contain one or more high density polyethylene polymers in an amount greater than about 90% by weight, such as in an amount greater than about 93% by weight, such as in an amount greater than about 95% by weight, such as in an amount greater than about 98% by weight. In one embodiment, a lubricant can be included in the polymer composition. The lubricant can be contained in the polymer composition in an amount less than about 5% by weight, such as in an amount less than about 2% by weight. The polymer composition and/or the high density polyethylene polymer resin can have a melt flow rate of less than about 1 g/10 min, such as less than about 0.5 g/10 min, such as less than about 0.1 g/10 min.

The exit zone contained in the twin screw extruder can be vented or unvented. The exit zone can have a length that is at least about 5% of the length of the screws, such as at least about 10% of the length of the screws, and less than about 40% of the length of the screws, such as less than about 20% of the length of the screws. In one embodiment, the entire twin screw extruder is not vented for producing the porous strand and the resulting porous pellets.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figure, in which:

FIG. 1 is a cross-sectional view of one embodiment of a twin screw extruder that may be incorporated into the process of the present disclosure.

Repeat use of reference characters in the present specification and drawings is intended to represent the same or analogous features or elements of the present invention.

### DEFINITIONS

The melt flow rate of a polymer or polymer composition is measured according to ISO Test 1133 at 190 °C and at a load of 21.6 kg.

Particle size including average particle size (d50) and particle size distribution is measured using laser diffraction/light scattering according to ISO Test 13320 (2020).

The average molecular weight of a polymer is determined using the Margolies'equation. Molecular weight can be determined by first measuring the viscosity number according to DIN EN ISO Test 1628. Dry powder flow is measured using a 25 mm nozzle.

As used herein, bulk density is measured according to DIN 53466.

Polymer density is determined according to ASTM Test D792 or D1505.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a process and system for converting a high density polyethylene resin powder into a pelletized product. In accordance with the present disclosure, a multi-screw extruder, such as a twin screw extruder, is used to process the high density polyethylene powder resin into a strand that is then cut into pellets. The extruder is designed to convert the high density polyethylene resin powder into pellets without degrading the polymer and in a controlled process. During the process, gases can be trapped within the strand that is produced resulting in the formation of porous pellets. The porous pellets can be produced efficiently and at high throughputs. In addition, the porous pellets, compared to powder, are easy to handle and well suited for feeding into molding processes, such as injection molding processes, for producing all different types of articles, components, and parts. For example, it is believed that the porous nature of the pellets makes them easier to melt process than pellets made from a solid, high density polyethylene polymer.

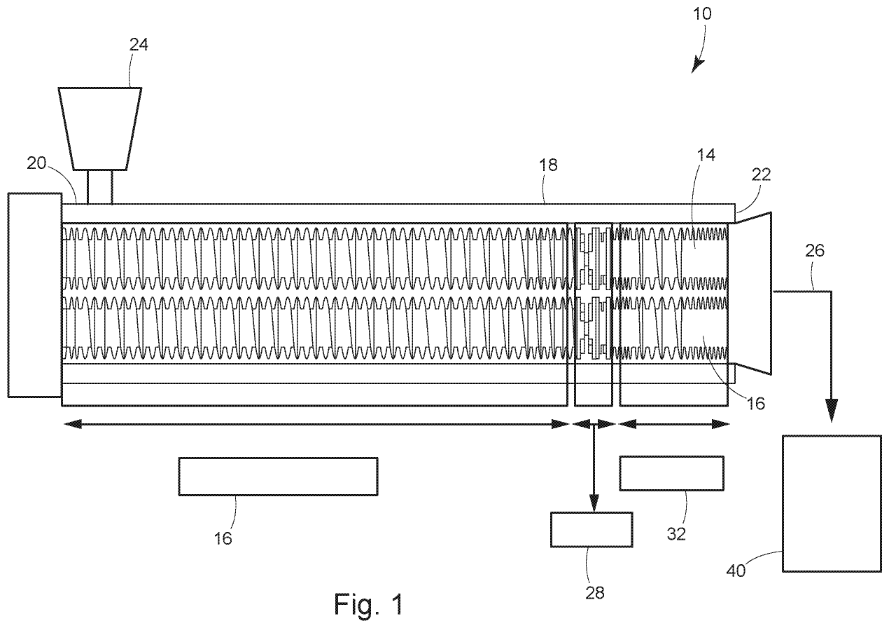

Referring to FIG. 1, one embodiment of a twin screw extruder that can be used in accordance with the present disclosure is shown. The twin screw extruder 10 is designed to heat a high density polyethylene polymer resin powder to a molten state under low shear conditions and produce a strand that is then pelletized. The twin screw extruder 10 includes a pair of cooperating screws 14 and 16 contained within a barrel 18. The barrel 18 includes a first end 20 spaced from a second and opposite end 22. As shown, the barrel 18 is in communication with a hopper 24. The hopper 24 is positioned at the first end 20 of the barrel 18. The hopper 24 is for receiving a polymer composition containing one or more high density polyethylene polymer resin powders. Each screw 14 and 16 are in operative association with a drive motor for controlling the speed and torque delivered to the screws. The screws 14 and 16 can rotate in the same direction or can rotate in opposite directions. As shown in FIG. 1, the screws 14 and 16 may intermesh. In other embodiments, however, the screws may not intermesh.

During the pelletization process, the high density polyethylene polymer resin powder is fed to the hopper 24 at controlled amounts and introduced into the barrel 18. Within the barrel 18, the high density polyethylene polymer resin powder is slowly heated into a molten state. The screws 14 and 16 push the polymer composition down through the barrel and out through an exit 26 in the form of a strand.

As shown in FIG. 1, the twin screw extruder 10 can include different zones including a conveying zone 16, a kneading zone 28, and an exit zone 32. In addition, the barrel 18 can be divided into sections with independent temperature control. For instance, the barrel 18 can be in communication with any suitable heating device. The polymer composition can be heated, for instance, through electrical resistance heaters, gas heaters, and the like.

In order to control the temperature within the barrel 18 at different points along the length, the barrel 18 can be in communication with a plurality of temperature control units. The temperature control units, for instance, can monitor the temperature of the barrel 18 and can send information to a controller, such as a microprocessor or programmable logic unit. The controller, in turn, can control the heating device for maintaining the temperature of the barrel at the various locations within preset temperature limits. The temperature control units can work in conjunction with a controller in a closed loop manner or an open loop manner.

In one embodiment, the barrel 18 can include at least 4 different independently controlled temperature sections, such as at least 6 temperature controlled sections, such as at least 8 temperature controlled sections, such as at least 10 temperature controlled sections, such as at least 12 temperature controlled sections. The twin screw extruder 10 can include generally less than about 20 independent temperature controlled sections along the length of the barrel.

In addition to controlling the temperature within the barrel, the control system of the present disclosure can also adjust the speed of the screws and various other parameters.

In accordance with the present disclosure, the twin screw extruder 10 as shown in FIG. 1 is operated under low shear conditions, at controlled temperatures, and using a relatively high L/D screw design in order to process high density polyethylene polymers. In general, any suitable high density polyethylene polymer can be pelletized in accordance with the present disclosure. The high density polyethylene polymer resin powder that is fed into the process is comprised of particles having an average particle size (d50) of greater than about 10 microns, such as greater than about 50 microns, such as greater than about 100 microns, such as greater than about 120 microns, and less than about 800 microns, such as less than about 600 microns, such as less than about 400 microns, such as less than about 200 microns. The high density polyethylene polymer particles can have a bulk density of from about 0.2 g/cm³ to about 0.6 g/cm³. In one aspect, for instance, the bulk density is from about 0.22 g/cm³ to about 0.38 g/cm³. Alternatively, the particles can have a higher bulk density, such as greater than about 0.38 g/cm³ to about 0.55 g/cm³.

The high density polyethylene polymer can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a very high molecular weight polyethylene and/or an ultrahigh molecular weight polyethylene.

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×106 g/mol. In some embodiments, the molecular weight of the ultra-high molecular weight polyethylene composition is between about 3×106 g/mol and about 30×106 g/mol, or between about 3×106 g/mol and about 20×106 g/mol, or between about 3×106 g/mol and about 10×106 g/mol, or between about 3×106 g/mol and about 6×106 g/mol In one aspect, ultra high molecular weight polyethylene can be a high density polyethylene homopolymer according to the specification of ASTM Test D4020.

In one embodiment, the high density polyethylene polymer comprises an ultrahigh molecular weight polyethylene polymer. For instance, the high density polyethylene polymer can have an average molecular weight of greater than about 400,000 g/mol, such as greater than about 600,000 g/mol, such as greater than about 800,000 g/mol, such as greater than about 1,000,000 g/mol, such as greater than about 1,500,000 g/mol, such as greater than about 2,000,000 g/mol, such as greater than about 2,500,000 g/mol, such as greater than about 3,000,000 g/mol, such as greater than about 3,500,000 g/mol. The molecular weight of the high density polyethylene polymer is generally less than about 12,000,000 g/mol, such as less than about 9,000,000 g/mol, such as less than about 8,000,000 g/mol, such as less than about 7,000,000 g/mol, such as less than about 6,000,000 g/mol, such as less than about 5,500,000 g/mol, such as less than about 5,000,000 g/mol.

Any method known in the art can be utilized to synthesize the high density polyethylene polymer particles. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene can be polymerized in gaseous phase or slurry phase at relatively low temperatures and pressures. The polymerization reaction may be carried out at a temperature of between 50 °C and 100 °C and pressures in the range of 0.02 and 2 MPa.

The molecular weight of the polyethylene can be adjusted by adding hydrogen. Altering the temperature and/or the type and concentration of the co-catalyst may also be used to fine tune the molecular weight.

Suitable catalyst systems include but are not limited to Ziegler-Natta type catalysts, metallocene catalysts, and/or post metallocene catalysts. Typically Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system could be obtained by the reaction of a titanium(IV) compound with a trialkyl aluminum compound in an inert organic solvent at temperatures in the range of −40 °C to 100 °C, preferably −20 °C to 50 °C. The concentrations of the starting materials are in the range of 0.1 to 9 mol/L, preferably 0.2 to 5 mol/L, for the titanium(IV) compound and in the range of 0.01 to 1 mol/L, preferably 0.02 to 0.2 mol/L for the trialkyl aluminum compound. The molar ratio of titanium and aluminum in the final mixture can be in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40 °C to 200 °C, preferably −20 °C to 150 °C. In the first step, the titanium(IV) compound is reacted with the trialkyl aluminum compound at temperatures in the range of −40 °C to 100 °C, preferably −20 °C to 50 °C using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10 °C to 150 °C, preferably 10 °C to 130 °C using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100 °C In a second reaction stage, the reaction mixture formed is subjected to heat treatment for a period of about 10 to 100 hours at a temperature of 110° to 200 °C accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

In one embodiment, especially when producing a relatively high molecular weight polyethylene, a metallocene-type catalyst may be used. For example, in one embodiment, two different metallocene-type catalysts can be used to produce the polyethylene polymer. For instance, the metallocene catalysts may be made from metals, such as hafnium and/or chromium.

Using such catalyst systems, the polymerization is normally carried out in suspension at low pressure and temperature in one or multiple steps, continuous or batch. The polymerization temperature is typically in the range of 30 °C to 130 °C, preferably in the range of 50 °C and 90 °C and the ethylene partial pressure is typically less than 10 MPa, preferably 0.05 and 5 MPa. Aluminum compounds can be used as co-catalyst such that the ratio of Al:Ti (co-catalyst versus catalyst) is in the range of 0.01 to 100:1, more preferably in the range of 0.03 to 50:1. The solvent is an inert organic solvent as typically used for Ziegler type polymerizations. Examples are butane, pentane, hexane, cyclohexane, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried. Salts of long chain fatty acids may be added as a stabilizer.

Generally a cocatalyst such as alumoxane or alkyl aluminum or alkyl magnesium compound is also employed. Other suitable catalyst systems include Group 4 metal complexes of phenolate ether ligands.

The high density polyethylene polymer generally has a relatively low melt flow rate. The melt flow rate, for instance, is generally less than about 3 g/10 min at 190 °C and at a load of 21.6 kg according to ISO Test 1133. For instance, the melt flow rate of the high density polyethylene polymer can be less than about 1 g/10 min, such as less than about 0.5 g/10 min, such as less than about 0.3 g/10 min, such as less than about 0.1 g/10 min.

The high density polyethylene polymer may be combined with various other additives prior to or during the extruding process. Other additives that may be contained in the polymer composition include heat stabilizers, light stabilizers, UV absorbers, acid scavengers, flame retardants, lubricants, colorants, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, molybdenum disulfide, or any combination thereof. When a lubricant is present in the polymer composition, the lubricant can be contained in the composition in an amount less than about 5% by weight, such as in an amount less than about 3% by weight, such as in an amount less than about 2% by weight, such as in an amount less than about 1% by weight, and in an amount greater than about 0.1% by weight, such as in an amount greater than about 0.5% by weight.

In one embodiment, a colorant may be present in the composition. The colorant may include, but is not limited to, inorganic and organic based color pigments.

In one aspect, an acid scavenger may be present in the polymer composition. The acid scavenger, for instance, may comprise an alkali metal salt or an alkaline earth metal salt. The salt can comprise a salt of a fatty acid, such as a stearate. Other acid scavengers include carbonates, oxides, or hydroxides. Particular acid scavengers that may be incorporated into the polymer composition include a metal stearate, such as calcium stearate. Still other acid scavengers include zinc oxide, calcium carbonate, magnesium oxide, and mixtures thereof.

These additives may be used singly or in any combination thereof. In general, each additive may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

In one embodiment, the polymer composition fed to the twin screw extruder 10 contains one or more high density polyethylene polymers in an amount greater than about 90% by weight, such as in an amount greater than about 93% by weight, such as in an amount greater than about 95% by weight, such as in an amount greater than about 97% by weight.

In one aspect, the polymer composition contains only a single high density polyethylene polymer. Alternatively, the polymer composition contains two polyethylene polymers, three polyethylene polymers, four polyethylene polymers or the like. For example the polymer composition can contain a first high density polyethylene polymer combined with a second high density polyethylene polymer. The first polyethylene polymer can have an average molecular weight of greater than about 400,000 g/mol, such as greater than about 500,000 g/mol and less than about 2 million g/mol, such as less than about 1 million g/mol, such as less than about 800,000 g/mol. The first polyethylene polymer can be present in the polymer composition in an amount of greater than about 10% by weight, such as greater than about 20% by weight, such as greater than about 30% by weight, such as greater than about 40% by weight, and less than about 90% by weight, such as less than about 70% by weight, such as less than about 60% by weight, such as less than about 50% by weight. The second polyethylene polymer can have an average molecular weight of greater than about 2 million g/mol, such as greater than about 3 million g/mol and less than about 8 million g/mol, such as less than about 6 million g/mol, such as less than about 5 million g/mol. The second polyethylene polymer can be present in the polymer composition in an amount of greater than about 10% by weight, such as greater than about 20% by weight, such as greater than about 30% by weight, such as greater than about 40% by weight, such as in an amount greater than about 50% by weight, such as greater than about 60% by weight and less than about 90% by weight, such as less than about 80% by weight, such as less than about 70% by weight, such as less than about 60% by weight.

As described above, the twin screw extruder 10 as shown in FIG. 1 is operated under low shear conditions in producing the pelletized product. The temperature is also controlled during the process. As shown in FIG. 1, the polymer composition fed to the extruder 10 stays in the conveying zone for a significant portion of the extruder length. In the conveying zone, the temperature is very gradually increased.

The conveying zone 28, for instance, can comprise greater than about 40% of the distance of the screws, such as greater than about 50% of the distance of the screws, such as greater than about 60% of the distance of the screws, such as greater than about 70% of the distance of the screws, and generally less than about 85% of the distance of the screws, such as less than about 80% of the distance of the screws. Within the conveying zone, the temperature is generally maintained below 100 °C for a significant portion of the conveying zone. For instance, the temperature within the barrel 18 can be maintained below about 60 °C, such as below about 50 °C, such as below about 40 °C, and greater than about 20 °C for at least about 30% of the distance of the screws, such as at least about 40% of the distance of the screws, and less than about 60% of the distance of the screws. In one aspect, at the end of the conveying zone 28, the temperature is gradually increased. The temperature exiting the conveying zone, for instance, can be from about 100 °C to about 170 °C, such as greater than about 120 °C and less than about 165 °C, such as less than about 160 °C.

From the conveying zone, the polymer composition is fed to the kneading zone 30. Within the kneading zone 30, each of the screws 14 and 16 can include spaced apart kneading elements. The kneading elements can be spaced apart in order to maintain low shear conditions.

The temperature in the kneading zone is sufficient for the polymer composition to at least soften or become molten. The temperature in the kneading zone, for instance, can be greater than about 170 °C, such as greater than about 180 °C, and less than about 220 °C, such as less than about 210 °C.

From the kneading zone 30, the polymer composition is fed to the exit zone 32. Within the exit zone 32, the polymer composition forms a strand, particularly a porous strand. In one aspect, the exit zone 32 can be generally greater than about 5% of the total length of the screws, such as greater than about 10% of the total length of the screws, and less than about 40% of the total length of the screws, such as less than about 30% of the total length of the screws, such as less than about 20% of the total length of the screws. The temperature in the exit zone can be greater than about 190 °C, such as greater than about 200 °C, such as greater than about 210 °C, and less than about 250 °C, such as less than about 240 °C, such as less than about 230 °C

During the extrusion process, devolatilized gases are created or emitted by the polymer composition and can include other gases contained in the barrel during the process. In one aspect, these gasses are released through one or more open vents in the barrel. Alternatively, the devolatilized gases remain in the barrel during the process to produce gas pressure. For example, in one aspect, the barrel 18 is only partially vented or is unvented during the process.

The screws 14 and 16 contained within the twin screw extruder 10 generally have a relatively large length to diameter ratio. For instance, the L/D can be greater than about 30, such as greater than about 34, such as greater than about 36, such as greater than about 38, such as greater than about 40, such as greater than about 42, such as greater than about 44, and less than about 70, such as less than about 66, such as less than about 64, such as less than about 60, such as less than about 56, such as less than about 54, such as less than about 50.

During the process, the screws 14 and 16 can rotate at a rate of from about 200 rpm to about 300 rpm.

As shown in FIG. 1, the strand produced during the process exits the twin screw extruder 10 and enters a cooling bath 40. The strand is then cut into pellets within the cooling bath 40. In one aspect, the resulting pellets can have a diameter of greater than about 1 mm, such as greater than about 2 mm, such as greater than about 3 mm, and less than about 8 mm, such as less than about 6 mm, such as less than about 5 mm. The length of the pellets can be greater than about 1 mm, such as greater than about 2 mm, such as greater than about 3 mm, such as greater than about 3.5 mm, and less than about 10 mm, such as less than about 8 mm, such as less than about 7 mm, such as less than about 6 mm, such as less than about 5 mm. The porosity of the strands or pellets can be greater than about 10%, such as greater than about 15%, such as greater than about 18%, such as greater than about 20%, such as greater than about 22%, such as greater than about 24% and less than about 50%, such as less than about 45%, such as less than about 40%, such as less than about 35%, such as less than about 30%, such as less than about 28%. Porosity is measured using mercury intrusion porosimetry.

Once the pellets are produced, the pellets can be fed into any suitable process for forming molded articles. The pellets are relatively easy to handle, especially in comparison to the resin powder that is fed into the extruder. The pellets of the present disclosure can be used to form all different types of parts, components, and articles. For instance, the pellets can be used to produce fibers including filaments and films.

In one aspect, the pellets can be fed into an injection molding apparatus for forming injection molded articles.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A process for forming a high density polyethylene product comprising:
feeding one or more high density polyethylene polymer resin powders into a twin screw extruder, at least one high density polyethylene resin powder having a density of about 0.92 g/cm3 or greater and having an average molecular weight of about 400,000 g/mol or greater, the twin screw extruder including a barrel that houses two cooperating screws, the barrel having a length that is divided into temperature sections, the screws having an L/D of about 30 or greater, the twin screw extruder including a conveying zone, a kneading zone, and an exit zone, and wherein the conveying zone is greater than about 50% of the length of the screws, and wherein over the first 40% of the length of the screws within the conveying zone, the temperature is maintained below 60 °C, and wherein the temperature is above 160 °C in the kneading zone and the exit zone causing the high density polyethylene powder to flow and form a porous strand, and
cutting the strand into pellets to form a porous pellet product.

2. A process as defined in claim 1, wherein the high density polyethylene polymer resin powder has an average molecular weight of greater than about 500,000 g/mol.

3. A process as defined in claim 1, wherein the high density polyethylene polymer resin powder has an average molecular weight of from about 1,500,000 g/mol to about 12,000,000 g/mol.

4. A process as defined in claim 1, wherein the high density polyethylene polymer resin powder contains at least two high density polyethylene polymers having different average molecular weights.

5. A process as defined in claim 1, wherein the high density polyethylene polymer resin powder is combined with a lubricant prior to feeding to the extruder, the lubricant being present in the resulting polymer composition in an amount less than about 5% by weight.

6. A process as defined in claim 1, wherein the screws have an L/D of about 34 or greater and less than about 70.

7. A process as defined in claim 1, wherein the conveying zone is greater than about 60% of the length of the screws and less than about 85% of the length of the screws.

8. A process as defined in claim 1, wherein at least 50% of the length of the barrel within the conveying zone is maintained at a temperature of less than about 55 °C.

9. A process as defined in claim 1, wherein the temperature in the kneading zone is greater than about 180 °C and less than about 250 °C.

10. A process as defined in claim 1, wherein the temperature in the exit zone is greater than about 180 °C and less than about 250 °C.

11. A process as defined in claim 1, wherein the exit zone is at least about 5% of the length of the screws and less than about 20% of the length of the screws.

12. A process as defined in claim 1, wherein the strand that is produced during the process is fed into a water bath and cut into the porous pellets.

13. A process as defined in claim 1, wherein the exit zone within the barrel is vented.

14. A process as defined in claim 1, wherein the twin screw extruder is not vented during the process.

15. A process as defined in claim 1, wherein devolitilized gases remain in the barrel during the process so as to produce a porous strand.

16. A process as defined in claim 1, wherein the high density polyethylene polymer resin powder has a melt flow rate of less than about 1 g/10 min.

17-19. (canceled)

20. A process as defined in claim 1, wherein the porous pellets contain one or more high density polyethylene polymers in an amount greater than about 90% by weight.

21. A process as defined in claim 1, wherein the porous pellet product is injection molded to form a three-dimensional article.

22. A porous pellet comprising:
a polymer composition containing at least one high density polyethylene resin having a density of about 0.92 g/cm3 or greater and having an average molecular weight of about 400,000 g/mol or greater, the polymer composition containing one or more high density polyethylene resins in an amount of greater than about 90% by weight, the porous pellet having a diameter of greater than about 1 mm and less than about 8 mm, the porous pellet having a length of greater than about 1 mm and less than about 10 mm, the porous pellet having a porosity of greater than about 10% and less than about 50%.

23-24. (canceled)

25. A porous pellet as defined in claim 22, wherein the porous pellet has a porosity of greater than about 15%, and less than about 45%.

26-27. (canceled)
